(19) United States
(12) Patent Application Publication
(10) Pub. No.: US 2005/0017594 A1
(43) Pub. Date: Jan. 27, 2005

(54) Stator for electric machines

(76) Inventors: Juergen Herp, Buehl (DE); Heiko Sponar, Rastatt (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/496,502

(22) PCT Filed: Sep. 20, 2002
(86) PCT No.: PCT/DE02/03546

(30) Foreign Application Priority Data
Jan. 31, 2002 (DE) 102 03 796.5

(51) Int. Cl. H02K 1/18; H02K 1/28

(52) U.S. Cl. 310/218; 310/259

(57) ABSTRACT

The present invention relates to a stator for an electrical machine, in particular an EC motor, comprising a plurality of metal sheets in the form of a packet of stacked laminations. Between each two poles of the stator, there is a respective joint region in which at least one recess is provided. The recess is embodied as a slot,-which extends at a predetermined angle (α) obliquely to a center axis of the stator.

### PRIOR ART

The present invention relates to a stator for an electrical machine, in particular an EC motor (electrically commutated motor), in which the stator is embodied of a plurality of laminations in the form of a packet of stacked laminations.

In a number of fields of application, electronically controlled electric motors are gaining ever-increasing importance. These are electric motors in which the requisite periodic switching of coils is no longer done by means of a commutator, but rather by electronic switch devices. One example of electronic switch devices is a rotor position sensor for finding when the stator and the rotor, for the coils that are to be switched at that specific moment, are in a relative position that is favorable to switching or that promotes switching.

From German Patent Disclosure DE 198 42 948 A1, an electric motor which has a stator produced from a lamination packet is known. The individual sheet-metal laminations have indentations so that adjacent laminations will mesh with one another. The individual poles are joined together at their pole pieces via a plurality of ribs, creating a rectilinear slot. The slot is formed of a plurality of short recesses, each separated by the ribs. Because of the rectilinear embodiment of the slots and the high number of ribs, however, this known electric motor has a relatively high locking moment and relatively low power.

### ADVANTAGES OF THE INVENTION

The stator according to the invention for an electrical machine, in particular an EC motor, is embodied such that because of an advantageous design of the slot, it has a very favorable locking moment. Moreover, an electrical machine with a stator according to the invention has high power. This is achieved according to the invention by providing that slots between two poles of the stator are embodied such that they extend at a predetermined angle obliquely to a center axis of the stator. According to the invention, the oblique slots can be embodied in continuous form, so that individual slots are not separated by ribs or the like. Thus a very favorable locking moment and high power can be achieved. The stator according to the invention can furthermore be produced very economically, since the stator can be formed of a plurality of laminations stacked one above the other that can be produced by stamping, for instance. The individual laminations are stamped in such a way that when they are placed one above the other, the slot is created, extending at an angle to the center axis as viewed across the height of the lamination packet. The stator packet is surrounded by a short-circuit ring, by way of which the flux flows.

To furnish a stator that is especially economical to produce, the slots of the stator packet are embodied in stepped form. The height of each step is equivalent to the thickness of one lamination. The various slits (stamped recesses) in one lamination are offset from those of the adjacent lamination by a predetermined angle in the circumferential direction, so that when the lamination packet is assembled, an obliquely extending, stepped slot is created; that is, the two long sides of the slot are in stairstep form.

In another preferred embodiment of the present invention, the slots of the stator lamination packet are linear, or in other words embodied with straight long sides and a constant width.

To keep the number of ribs as low as possible, for the sake of attaining the highest possible power, the stator packet and the short-circuit ring are preferably joined together by a positive-engagement joint. The positive engagement furthermore assures that the air gaps created will be as small as possible, so as to keep the power losses as slight as possible. The positive-engagement joint is preferably embodied at the end regions of the poles which protrude outward from the stator. By way of example, the positive-engagement joint can be embodied as a dovetail joint, a T-shaped joint, or any arbitrary positive-engagement joint. Either the protruding region of the joint at the poles of the stator and the receiving region of the joint can be embodied on the short-circuit ring, or the protruding region of the joint is embodied on the short-circuit ring while the receiving region of the joint is at the poles.

Preferably, the angle between the center axis of the stator and the obliquely positioned slot is between 15° and 20°, and especially preferably it is 18°.

A connection of the poles is preferably made such that in the uppermost and lowermost laminations of the stator lamination packet, there are no slits. As a result, improved stability of the lamination packet can also be achieved.

In another preferred embodiment of the present invention, a plurality of oblique slots which are offset parallel from one another longitudinally of the stator are formed between two poles. As a result, it is attained that the stator is mechanically more stable, but with an increasing number of the resultant additional connecting ribs, it loses power. It should be noted that if there are a plurality of slots, the slots can be embodied such that they partly overlap in the direction of the height of the stator lamination packet, or that between individual slots there is one lamination each without recesses, to improve the stability of the lamination packet.

In another preferred embodiment of the present invention, the oblique slot according to the invention comprises a plurality of shorter slots, which are disposed in a row. The plurality of smaller slots is thus disposed in a row, one after the other, and when made from metal sheets is for instance separated by one sheet thickness each. From the standpoint of production, such a slot can for instance be produced in a simple fashion by providing that individual laminations between the smaller slots are not provided with a recess, so that the result is a linear arrangement having a plurality of short, oblique slits.

The lamination packet of the invention for the stator is preferably used in an EC motor, in which windings are applied to the stator.

### DRAWINGS

In the ensuing description, a plurality of exemplary embodiments of the invention are described in detail.

Shown are:

FIG. 1, a schematic, perspective fragmentary view of a stator lamination packet in a first exemplary embodiment of the present invention;

FIG. 2, a schematic perspective view of a stator lamination packet in a second exemplary embodiment of the present invention;

FIG. 3, a perspective fragmentary view of the stator lamination packet, shown in FIG. 2, from a different angle; and

FIG. 4, a plan view on a stator lamination packet with a short-circuit ring, in a third exemplary embodiment of the present invention.

### DESCRIPTION OF THE EXEMPLARY EMBODIMENTS

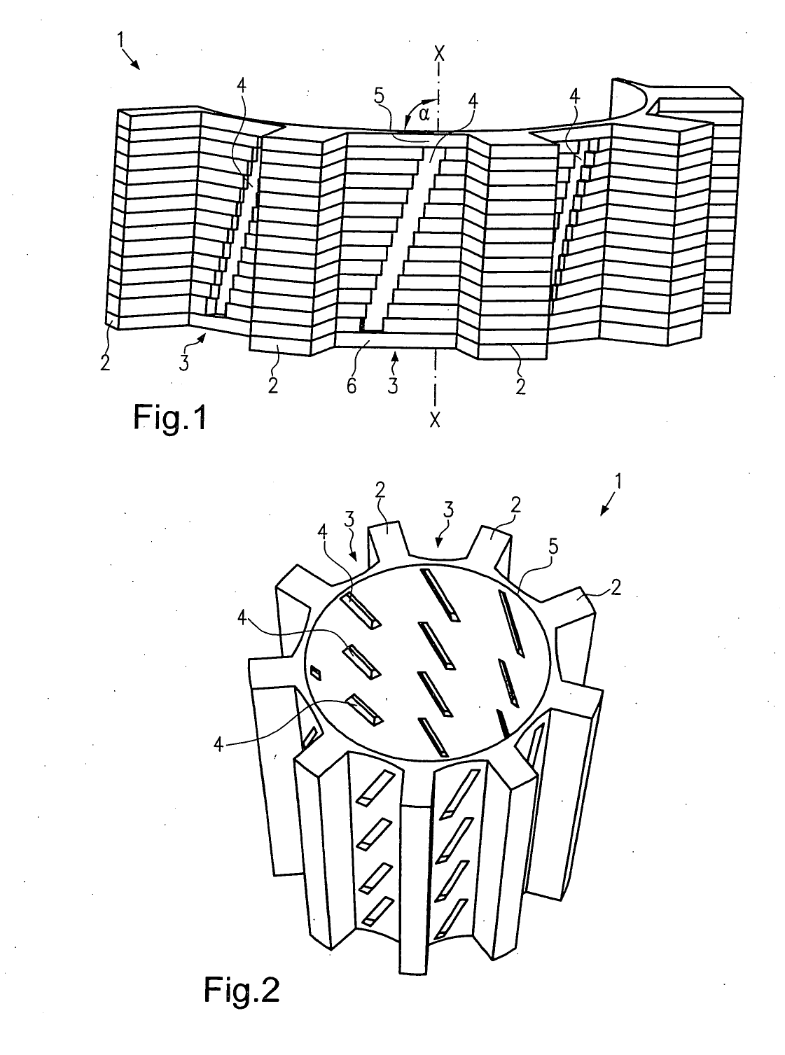

A stator 1 in a first exemplary embodiment of the present invention will now be described, referring to FIG. 1.

As shown in FIG. 1, the stator 1 includes a plurality of toothlike, outward-oriented poles 2. Between each two adjacent poles is a respective joint region 3 of a lesser thickness. The stator lamination packet is composed of a plurality of individual metal sheets, stacked one above the other. The sheets are preferably stamped out, making them easy to produce in terms of manufacturing technology.

As can be seen from FIG. 1, continuous slots 4 are formed in each of the joint regions 3. The slots 4 have a steplike or stairsteplike shape. This stepped shape is attained by providing that in the individual sheets, the recesses, which in the assembled state result in the slot 4, are each stamped out offset from one another by a certain angle in the circumferential direction. Thus the height of each individual step of the slot 4 is equivalent to the thickness of one sheet. It should be noted that it is understood that a plurality of sheets disposed one above the other can instead all be provided with the same recess; in that case, the step height of the slot is no longer the same as the sheet thickness but instead is the sum of the sheets stacked above one another that all have the same recess.

By means of this oblique position of the slot 4 in the stator 1, a markedly improved locking moment can be attained. As can be seen from FIG. 1, to improve the stability of the stator, the top sheet 5 of the lamination packet and the bottom sheet 6 of the lamination packet can each be embodied without a recess. Since according to the invention the slots 4 are embodied in continuous form, or in other words the slots 4 extend continuously from the bottom sheet 6 to the top sheet 5, very high power can still be achieved.

As FIG. 1 shows, the slots 4 are disposed at an angle α of approximately 20° to a center axis X-X of the stator 1. The slot 4 is embodied such that it does not directly adjoin the teeth of the poles 2 on both of its ends, but instead stays spaced apart from the poles 2 by a certain distance.

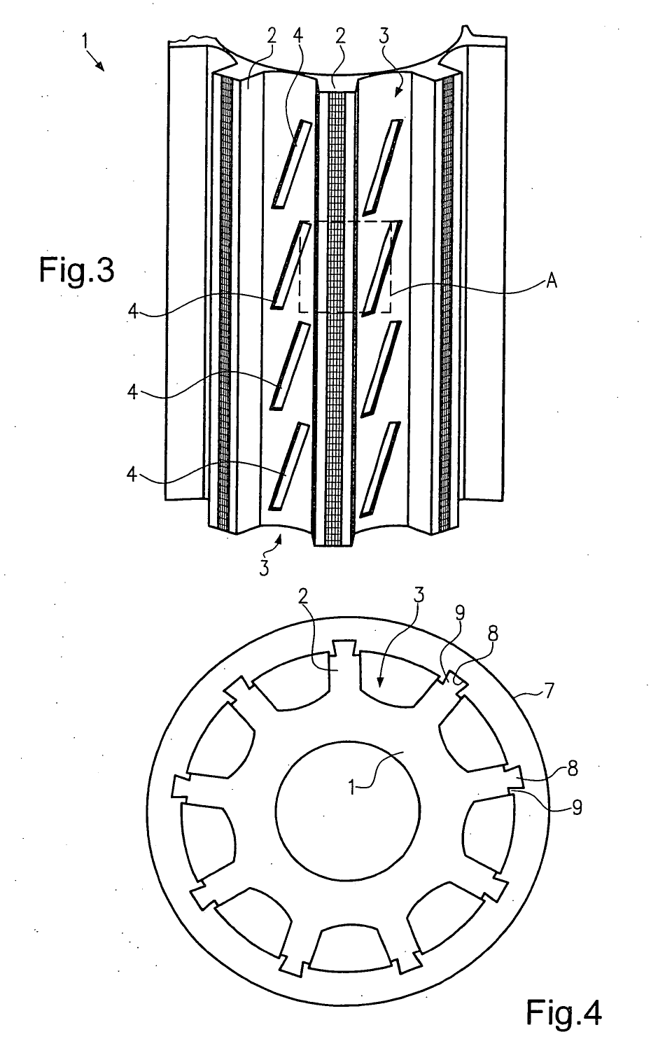

In FIGS. 2 and 3, a stator in accordance with a second exemplary embodiment of the present invention is shown. Elements that are the same or functionally the same are identified by the same reference numerals as in the first exemplary embodiment.

As shown in FIG. 2, the stator 1 essentially corresponds to the stator of the first exemplary embodiment. In a distinction from the first exemplary embodiment, however, instead of one continuous slot 4 between two adjacent pole teeth 2 at the joint regions 3, there are a plurality of continuous slots 4, namely precisely four of them. To improve the stability of the stator 1, the slots 4 of a joint region 3 are disposed such that they do not overlap in the direction of the height of the stator, that is, in the direction of the center axis X-X. In other words, in the lamination packet, one sheet without a recess is disposed between each two adjacent slots 4. Because of the thus-formed ribs between the individual slots 4, the stator does lose some percentage of its power, but is constructed mechanically more stably.

The slots 4 have a length such that they extend over a plurality of sheets. In the exemplary embodiments shown in FIGS. 2 and 3, the slots 4 have a height in the direction of the center axis X-X of the stator 1 that is approximately equivalent to ⅕ the height of the total stator packet.

As shown in FIG. 3, because of the embodiment of a plurality of slots 4 in each joint region, it is possible for a tooth segment A between the slots to break off. To prevent this, in FIG. 4 a third exemplary embodiment of the present invention is shown, in which once again the same elements are identified by the same reference numerals.

To prevent a tooth segment A from breaking off, the toothed ring of the stator 1 is embodied such that it has dovetail-like protrusions 9 on the ends of the poles 2. These dovetail-like protrusions 9 engage complementary recesses 8 that are formed on an inner circumference of a short-circuit ring 7. Thus by means of positive engagement, the stator 1 is firmly joined to the short-circuit ring 7. It is thereby assured that each stator tooth segment A is likewise joined to the short-circuit ring 7 by positive engagement and hence cannot break off.

It should be noted that instead of the dovetail-like positive engagement, a T-shaped, L-shaped or circular-segmental positive engagement, or other arbitrarily embodied geometric positive engagements, are possible.

Thus the present invention relates to a stator for an electrical machine, in particular an EC motor, comprising a plurality of metal sheets in the form of a packet of stacked laminations. Between each two poles 2 of the stator 1 there is a respective joint region 3, in which at least one recess 4 is provided. The recess is embodied as a slot, which extends at a predetermined angle α obliquely to a center axis X-X of the stator.

The above description of the exemplary embodiments of the present invention is intended solely for illustrative purposes and not for limiting the scope of the invention. Various changes and modifications may be made without departing from the scope of the invention or its equivalents.

1-10. (canceled)

11. A stator for an electrical machine, in particular an EC motor, comprising
a stator having a plurability of poles (2) and a plurality of metal sheets in the form of a packet of stacked laminations,
a joint region (3) between each two poles (2)
at least one recess (4) disposed in each joint region (3)
the recess (4) being embodied as a slot which extends at a predetermined angle (α) obliquely to a center axis (X-X) of the stator.

12. The stator of claim 11, wherein the slots (4) in the stator lamination packet are embodied in steplike form.

13. The stator of claim 11, wherein the slots (4) in the stator lamination packet are embodied linearly, with a constant width.

14. The stator of claim 11, further comprising a positive-engagement joint embodied between the stator lamination packet and a short-circuit ring (7).

15. The stator of claim 12, further comprising a positive-engagement joint embodied between the stator lamination packet and a short-circuit ring (7).

16. The stator of claim 13, further comprising a positive-engagement joint embodied between the stator lamination packet and a short-circuit ring (7).

17. The stator of claim 14, wherein the positive-engagement joint is embodied as a dovetail joint, a T-shaped joint, or an L-shaped joint.

18. The stator of claim 15, wherein the positive-engagement joint is embodied as a dovetail joint, a T-shaped joint, or an L-shaped joint.

19. The stator of claim 16, wherein the positive-engagement joint is embodied as a dovetail joint, a T-shaped joint, or an L-shaped joint.

20. The stator of claim 11, wherein the angle (α) between the center axis (X-X) of the stator and the slots (4) is between 15° and 20°.

21. The stator of claim 12, wherein the angle (α) between the center axis (X-X) of the stator and the slots (4) is between 15° and 20°.

22. The stator of claim 13, wherein the angle (α) between the center axis (X-X) of the stator and the slots (4) is between 15° and 20°.

23. The stator of claim 14, wherein the angle (α) between the center axis (X-X) of the stator and the slots (4) is between 15° and 20°.

24. The stator of claim 11, wherein the uppermost lamination (5) of the stator lamination packet and the lowermost lamination (6) of the stator lamination packet have no slits.

25. The stator of claim 12, wherein the uppermost lamination (5) of the stator lamination packet and the lowermost lamination (6) of the stator lamination packet have no slits.

26. The stator of claim 13, wherein the uppermost lamination (5) of the stator lamination packet and the lowermost lamination (6) of the stator lamination packet have no slits.

27. The stator of claim 11, wherein the recess formed between two poles (2) in the joint region (3) is formed by a plurality of slots (4) which are offset parallel to one another in the direction of the center axis (X-X) of the stator.

28. The stator of claim 12, wherein the recess formed between two poles (2) in the joint region (3) is formed by a plurality of slots (4) which are offset parallel to one another in the direction of the center axis (X-X) of the stator.

29. The stator of claim 13, wherein the recess formed between two poles (2) in the joint region (3) is formed by a plurality of slots (4) which are offset parallel to one another in the direction of the center axis (X-X) of the stator.

30. The stator of claim 27, further comprising one lamination in which there are no slits in the stator lamination packet between each of the individual slots (4).

31. The stator of claim 11, wherein the slot (4) comprises a plurality of slits disposed in a row.
